(19) United States
(12) Patent Application Publication
(10) Pub. No.: US 2017/0099267 A1
(43) Pub. Date: Apr. 6, 2017

(54) SYSTEMS AND METHODS FOR PKCS #8 PRIVATE FILE KEY SUPPORT

(71) Applicants: James R. Heit, Roseville, MN (US); Robert L. Bergerson, Roseville, MN (US); Jason C. Schultz, Roseville, PA (US); John A. Peters, Roseville, MN (US)

(72) Inventors: James R. Heit, Roseville, MN (US); Robert L. Bergerson, Roseville, MN (US); Jason C. Schultz, Roseville, PA (US); John A. Peters, Roseville, MN (US)

(73) Assignee: Unisys Corporation, Blue Bell, PA (US)

(21) Appl. No.: 14/872,317

(22) Filed: Oct. 1, 2015

(51) Int. Cl. H04L 29/06

(52) U.S. Cl. CPC H04L 63/0435; H04L 63/061; H04L 63/083

(57) ABSTRACT

A communications platform may provide asymmetric cryptography using RSA and/or DSA algorithms using a public and private key pair. The communications platform and corresponding cryptographic function library may be modified to add compatibility with multiple public-key cryptography standards (PKCS). Compatibility with PKCS #8 format may enable the communications platform to receive and decrypt encrypted private key files from another communications platform.

The instant disclosure relates to providing PKCS #8 private key file support for various network communications platforms. More specifically, this disclosure relates to modifications made to various network communications platforms to support transfers of private key encryption files created in PKCS #8 format.

### BACKGROUND

A communications platform, such as Unisys CPComm or CPCommOS, is a high-speed communications product that may connect application programs on a network server with terminals, workstations, and other applications in a data communications network. A communications platform software package may provide many key attributes, including, for example, high reliability, high throughput, low latency, security, support of open communications standards, and ease of administration. Applications on the network server may use the communications platform to connect to various types of networks, such as Ethernet and FDDI networks. The network may contain various hardware and software products that conform to open systems standards. The communications platform may implement TCP/IP protocols.

As part of their security protocol, communications platforms may support RSA and DSA encryption algorithms that provide for asymmetric cryptography using a public and private key pair. These encryption algorithms may be used by the communications platform during a SSL/TLS networking protocol handshake. The code for the algorithms themselves may be provided in a cryptography library product such as Unisys CryptoLib. The communications platform may call functions from the cryptography library to encrypt and decrypt files.

In some embodiments, the private key may be provided by a user in a file which is specified in a communications platform configuration file. The format of this file may be specified by various industry standards, such as different versions of the Public-Key Cryptography Standards (PKCS). However, different communications platforms may not support all file formats. For example, the communications platform and the cryptography library may support the format specified by the PKCS #1 standard, but may not support the format specified by the PKCS #8 standard. Certain communications platforms, such as, for example, Unisys CPCommOS/SAIL may support both formats. In some embodiments, a communication platform that supports both PKCS #1 and PKCS #8 may use the PKCS #8 format being generated as a default format when private keys are created.

In some situations, it may be desirable to move a private key file created in PKCS #8 format to a communications platform that does not support. PKCS #8 format. In such cases, a communications platform initialization error may occur. Therefore, it may be desirable to have different communications platforms support both PKCS formats to allow for a streamlined file transfer process.

### SUMMARY

According to one embodiment, a method of transferring private key files between two or more communications platforms includes receiving, by a server comprising at least one processor, a private key file; determining that a header type of the private key file is in a first type of private key file format; determining that the server has compatibility with the first type of private key file format; determining that the private key file is encrypted; calling one or more first cryptographic functions from a cryptographic function library, the one or more cryptographic functions being compatible with the first type of private key file format; and executing the one or more cryptographic functions.

In some embodiments, the method of transferring private key files between two or more communications platforms further includes determining that a header type of the private key file is in a second type of private key file format; and calling one or more second cryptographic functions from a cryptographic function library, the one or more cryptographic functions being compatible with the second type of private key file format. In some embodiments, determining that the server has compatibility with the first type of private key file format is performed upon initialization of the server.

In some embodiments, the method further includes determining that the server does not have compatibility with the first type of private key file format; and sending at least one error message. In some embodiments, the one or more first cryptographic functions comprise a password for decrypting the private key file, in some embodiments, the method further includes receiving an incorrect password for the private key file; and sending at least one error message.

According to another embodiment, a computer program product includes a non-transitory computer readable medium having code to receive a command from an operator; code to receive, by a server comprising at least one processor, a private key file; code to determine that a header type of the private key file is in a first type of private key file format; code to determine that the server has compatibility with the first type of private key file format; code to determine that the private key file is encrypted; code to call one or more first cryptographic functions from a cryptographic function library, the one or more cryptographic functions being compatible with the first type of private key file format; and code to execute the one or more cryptographic functions.

In some embodiments, the medium further includes code to determine that a header type of the private key file is in a second type of private key file format; and code to call one or more second cryptographic functions from a cryptographic function library, the one or more cryptographic functions being compatible with the second type of private key file format. In some embodiments, the determination that the server has compatibility with the first type of private key file format is performed upon initialization of the server.

In some embodiments, the medium further includes code to determine that the server does not have compatibility with the first type of private key file format; and code to send at least one error message. In some embodiments, the one or more first cryptographic functions comprise a password for decrypting the private key file. In some embodiments, the medium further includes code to receive an incorrect password for the private key file; and code to send at least one error message.

According to a further embodiment, an apparatus includes a memory for storing a database and includes a processor coupled to the memory. The processor is configured to receive, by a server comprising at least one processor, a private key file; to determine that a header type of the private key file is in a first type of private key file format; to determine that the server has compatibility with the first type of private key file format; to determine that the private key file is encrypted; to call one or more first cryptographic functions from a cryptographic function library, the one or more cryptographic functions being compatible with the first type of private key file format; and to execute the one or more cryptographic functions.

In some embodiments, the processor is further configured to determine that a header type of the private key file is in a second type of private key file format; and to call one or more second cryptographic functions from a cryptographic function library, the one or more cryptographic functions being compatible with the second type of private key file format. In some embodiments, the processor determines that the server has compatibility with the first type of private key file format upon initialization of the server.

In some embodiments, the processor is further configured to determine that the server does not have compatibility with the first type of private key file format; and to send at least one error message. In some embodiments, the one or more first cryptographic functions comprise a password for decrypting the private key file. In some embodiments, the processor is further configured to receive an incorrect password for the private key file; and to send at least one error message.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an exemplary system allowing for a transfer of PKCS files between different types of communications platforms according to one embodiment of the disclosure.

FIG. 2 is a block diagram illustrating a modified exemplary system allowing for a transfer of PKCS files between different types of communications platforms according to one embodiment of the disclosure.

FIG. 3 is a flow chart illustrating an exemplary method for executing a. PKCS file transfer between communications platforms according to one embodiment of the disclosure.

FIG. 4 is block diagram illustrating a computer network according to one embodiment of the disclosure.

FIG. 5 is a block diagram illustrating a computer system according to one embodiment of the disclosure.

FIG. 6A is a block diagram illustrating a server hosting an emulated software environment for virtualization according to one embodiment of the disclosure.

FIG. 6B is a block diagram illustrating a server hosing an emulated hardware environment according to one embodiment of the disclosure.

### DETAILED DESCRIPTION

In some embodiments, a communications platform that already supports PKCS #8 files may be modified to allow for the configuration of an encrypted private key password to be identical to what will be implemented for communications platforms that only support PKCS #1 formats. This may allow for additional security than providing the password in clear text in the configuration file of the communications platform.

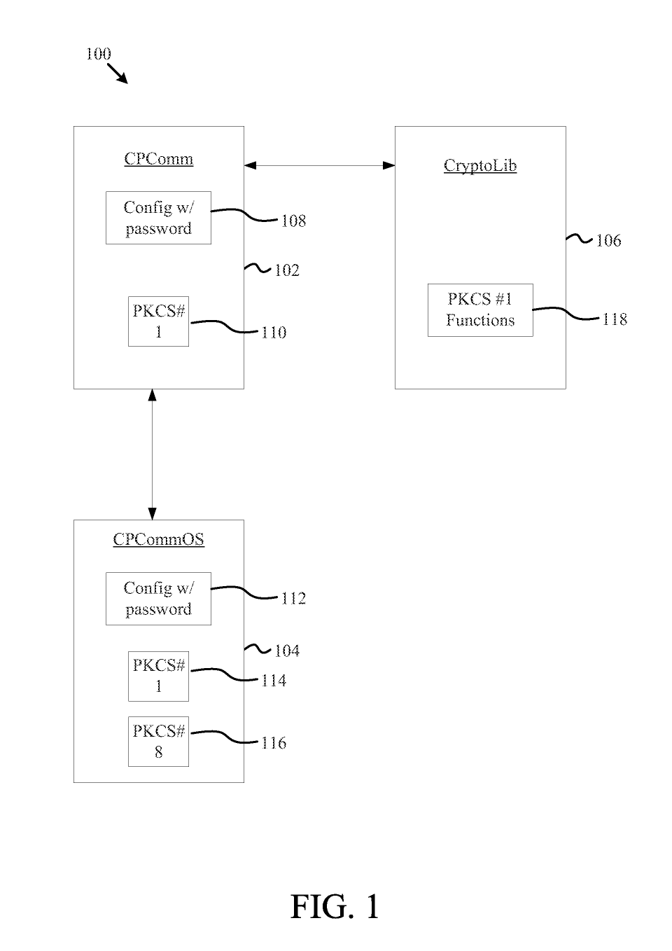

FIG. 1 is a block diagram illustrating an exemplary system 100 allowing for a transfer of PKCS files between different types of communications platforms. In the embodiment shown, a first type of communications platform 102 and a second type of communications platform 104 may be provided. In some embodiments, communications platform 102 may be a Unisys CPComm platform and communications platform 104 may be a Unisys CPCommOS platform. In the embodiment shown, a cryptographic function library 106 may be provided. In some embodiments, various encryption and decryption functions may be stored in library 106. These functions may be called by one or more of communications platform 102 and communications platform 104.

In the embodiment shown, communications platform 102 may comprise configuration file 108 and PKCS #1 module 110. In some embodiments, configuration file 108 may contain an encryption password for a private key file. The password may be provided in clear text in configuration file 108 or may be provided in a separate file. Configuration file 108 may be protected by various file access restrictions to prevent unauthorized access to the encryption password. In the embodiment shown, PKCS #1 module 110 enables the private key file to be formatted in PKCS #1 format.

Similarly, communications platform 104 may comprise configuration file 112, PKCS #1 module 114, and PKCS #8 module 116. In the embodiment shown, PKCS #1 module 114 enables a private key file stored or specified in configuration file 108 to be formatted in PKCS #1 format and PKCS #8 module 116 enables a private key file stored or specified in configuration file 108 to be formatted in PKCS #8 format.

When storing or loading the private key file, communications platform 102 may call one or more PKCS #1 cryptographic functions contained in cryptographic function library 106. However, in the embodiment shown, communications platform 102 does not support private key files stored in PKCS #8 format. Therfore, in the embodiment shown, if a private key file stored in PKCS #8 format is moved from communications platform 104 to communications platform 102, an initialization error may occur. In order to avoid incompatibility between platforms, certain modifications may be made to communications platform 102, communications platform 104, and cryptographic function library 106.

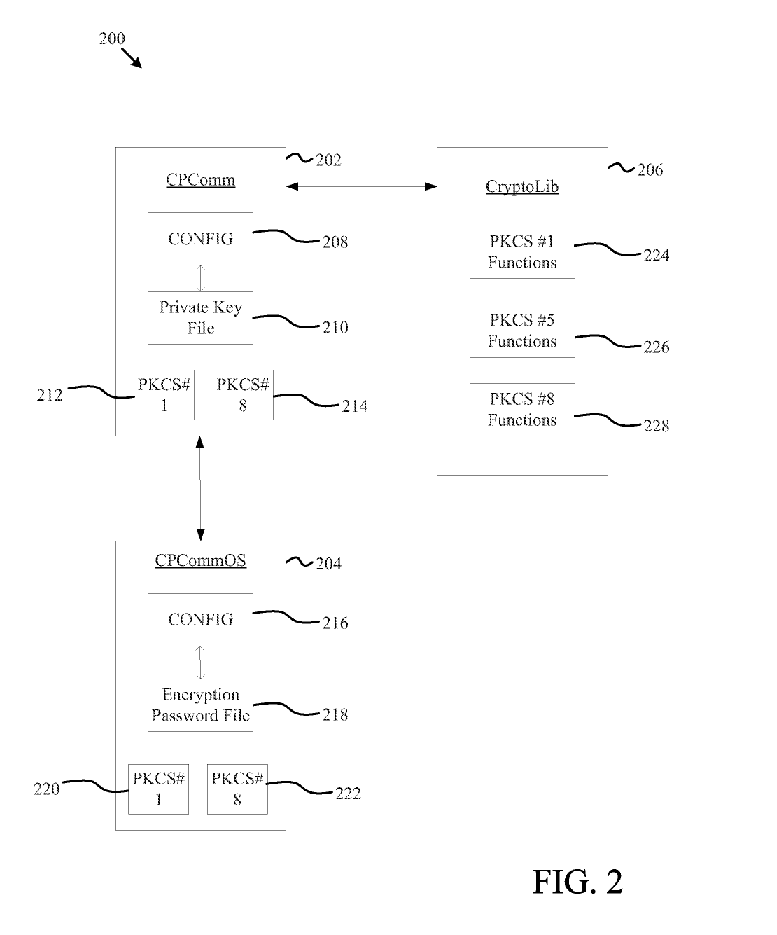

FIG. 2 is a block diagram illustrating a modified exemplary system 200 allowing for a transfer of PKCS files between different types of communications platforms according to one embodiment. Similar to the embodiment shown in FIG. 1, a first type of communications platform 202, a second type of communications platform 204, and cryptographic function library 206 may be provided. Also similar to the embodiment shown in FIG. 1, communications platform 202 may comprise configuration file 208 and PKCS #1 module 212. Similarly, communications platform 204 may comprise configuration file 216, PKCS #1 module 220, and PKCS #8 module 222 while cryptographic function library 206 may comprise PKCS #1 functions. In the embodiment shown in FIG. 2, communications platform 202 may further comprise PKCS #8 module 214 while cryptographic function library 206 may further comprise PKCS #8 functions 228. These modifications may harmonize the transfer of PKCS #8 files from communications platform 204 to communications platform 202 without errors,

PKCS #8 functions 228 in cryptographic function library 206 may be added to allow library 206 to recognize the different PEM header type used on PKCS #8 private key files and to process private keys in the PKCS #8 format. For example, PKCS #1 files may have a header/footer of: -----BEGIN RSA PRIVATE KEY----- ----- END ISA PRIVATE KEY----- or -----BEGIN DSA PRIVATE KEY----- -----END DSA PRIVATE KEY-----. PKCS #8 files may have a header/footer of: -----BEGIN PRIVATE KEY----- -----END PRIVATE KEY----- or -----BEGIN ENCRYPTED PRIVATE KEY----- -----END ENCRYPTED PRIVATE KEY-----. In the embodiment shown, cryptographic function library 206 may contain functions to provide functions to process private key files in both PKCS #1 and PKCS #8 formats.

In the embodiment shown, PKCS #1 module 212 and PKCS #8 module 214 may comprise RSA and/or DSA utilities that enable communications platform 202 to be compatible with both PKCS #1 and PKCS #8 formats. PKCS #8 format allows for the encryption of a private key, which is not supported by PKCS #1 format. This may provide an additional level of security when combined with providing file access restrictions on the configuration file 208. Encrypted private key files may also protect the private key when files are moved between communications platform 202 and communications platform 204, By providing PKCS #8 module 214 in communications platform 202, private keys that are generated on other platforms in PKCS #8 format may be recognized.

In this way, security may be improved by allowing the private key to be encrypted. Rather than having the encryption password contained in the configuration file as shown in the embodiment of FIG. 1, it may be contained in an encryption password file 218. If communications platform 202 receives an encrypted PKCS #8 file from communications platform 204, configuration file 208 may specify encryption password file 218 to provide the password for the received encrypted PKCS #8 file. Configuration file 208 may still have file access restrictions, thereby providing an additional layer of security.

In some embodiments, both communications platform 202 and cryptographic function library 206 contain the applicable PKCS #8 modules 214 and 228, respectively in order to support a PKCS #8 file transfer from communications platform 204. PKCS #8 function module 228 may comprise one or more APIs for use with PKCS #8 files. In some embodiments, PKCS #8 function module 228 may also comprise APIs or may call external API functions for accessing PKCS #5 functions to convert passwords to useable encryption keys while processing a PKCS #8 file. In some embodiments, PKCS #5 function module 226 may comprise PKCS #5 API functions and may be included in cryptographic function library 206. Communications platform 202 may be able to determine if cryptographic function library 206 contains PKCS #8 function module 228 upon initialization. For example, communications platform 202 may check an interface number returned by an initialization function called from cryptographic function library 206. The interface number may be different between libraries that support or do not support PKCS #8 format. In this manner, communications platform 202 may determine if the version of cryptographic function library 206 supports the PKCS #8 format. Communications platform 202 may display informative user messages if the user or the file header gives an indication the file is in PKCS #8 format (for example, an encryption password) and cryptographic function library 206 does not support it.

While PKCS #1 does not support encrypted files, a PKCS #8 file may contain an indication of whether it is an RSA or DSA key file, and if the private key is encrypted, in the encoding of the file. The encryption password for a private key file may be provided in configuration file 208. In some embodiments, the encryption password for a private key file may be provided in an SDF file(.elt) specified in configuration file 208.

In some embodiments, configuration file 208 of communications platform 202 may contain a SSL/TLS-SECURITY configuration statement having RSA and/or DSA key fields. In some embodiments, these fields may have a format of RSA-PRIVATE-KEY-FILE and DSA-PRIVATE-KEY-FILE, respectively. In some embodiments, these field may be used if a PKCS #8 private key file contains an encrypted key. These fields may specify the encryption password, or the file or file element name containing the encryption password. The private key file may have strong access restrictions to secure the file so that it can be accessed only by those authorized, and make sure the element is always available.

Some example formats of these fields may be RSA-PRIVATE-KEY-FILE, privqual*file.(elt)[,passqual*file.(elt)\password] for RSA key files and DSA-PRIVATE-KEY-FILE, privqual*file.(elt)[,passqual*file.(elt)\password] for DSA key files. Field privqual*file.(elt) may he a name of an ASCII PEM-formatted SDF file or symbolic file element that contains the RSA private key corresponding to a security profile, such as encrypted private key file 210. The key may be an RSA or DSA key in PKCS #1 or PKCS #8 PEM format. In some embodiments, access to this file element may be restricted to a security administrator, PKI key and certificate generation utilities, and communications platform 202. In some embodiments, this file and associated certificate may be generated and provided by utilities other than those provided by communications platform 202. A PKI key utility maybe used to generate or verify a private key file. A certificate utility may be used to verify that a private key matches a public key provided in a certificate. If the security of the private key is compromised, the key and its associated certificate may be revoked and a new RSA or DSA private key and certificate issued.

Field passqual*file.(elt) may be the name of an ASCII PEM-formatted SDF file or symbolic file element that contains the password that was used to encrypt the private key file. In the embodiment shown, this may be encryption password file 218. As discussed above, PKCS #8 formatted private key files may allow the private key to be encrypted. This password may be provided as input when the private key file is created and may be used to access the private key when necessary. This method of providing the private key encryption password may be preferable to providing the password directly in configuration file 208, as it may be likely that more stringent file protections can be applied to encryption password file 218 than configuration file 208. Appropriate protections may be placed on this password file so that the password is not compromised. Field password contains the optional case-sensitive password discussed above that may be used to encrypt the private key file, such as encryption password file 218. In some embodiments, this field may be limited to 32 ASCII characters, and may not contain spaces, commas, or periods.

Similar elements may be provided for communications platform 204. In some embodiments, a password for an encrypted private key may be provided in configuration file 216 in clear text, requiring configuration tile 216 to have strong access protections. In other embodiments, communications platform 204 may allow the password to be provided in a separate file or file element such as encryption password file 218. In this case, encryption password file 218 may have strict access protections rather than configuration file 216. In this way, protection of an encrypted private key file may be increased by allowing its encryption password to be contained in a highly protected external file or file element such as encryption password file 218.

Similar to configuration file 208 of communications platform 202 discussed above, configuration file 216 of communications platform 204 may contain a SSL/TLS-SECURITY configuration statement having RSA and/or DSA key fields. Some example formats of these fields may be RSA-PRIVATE-KEY-FILE, privfile.ext [,passqual*file.(elt)\password] for RSA key files and DSA-PRIVATE-KEY-FILE, privfile.ext [,passqual*file.(elt)\password] for DSA key files. Field privfile.ext may be a case-sensitive name of an ASCII PEM-formatted file residing in a directory that contains a RSA private key corresponding to a security profile, such as encrypted file 218. The key may be an RSA or DSA key in PEM format. In some embodiments, access to this file may be restricted to a security administrator and communications platform 204. Directory default access restrictions may also make the file only available to a root user. In some embodiments, a Network SSL/TLS certificate manager module may be used to generate and store a private key file and certificate. A third party utility may also be used to generate the files. If the security of this key is compromised, the key and its associated certificate may be revoked, and a new RSA or DSA private key and certificate issued. In some embodiments, this field may be limited to 72 ASCII characters. Fields passqual*file.(elt) and password may be similar to those discussed above with reference to communications platform 202.

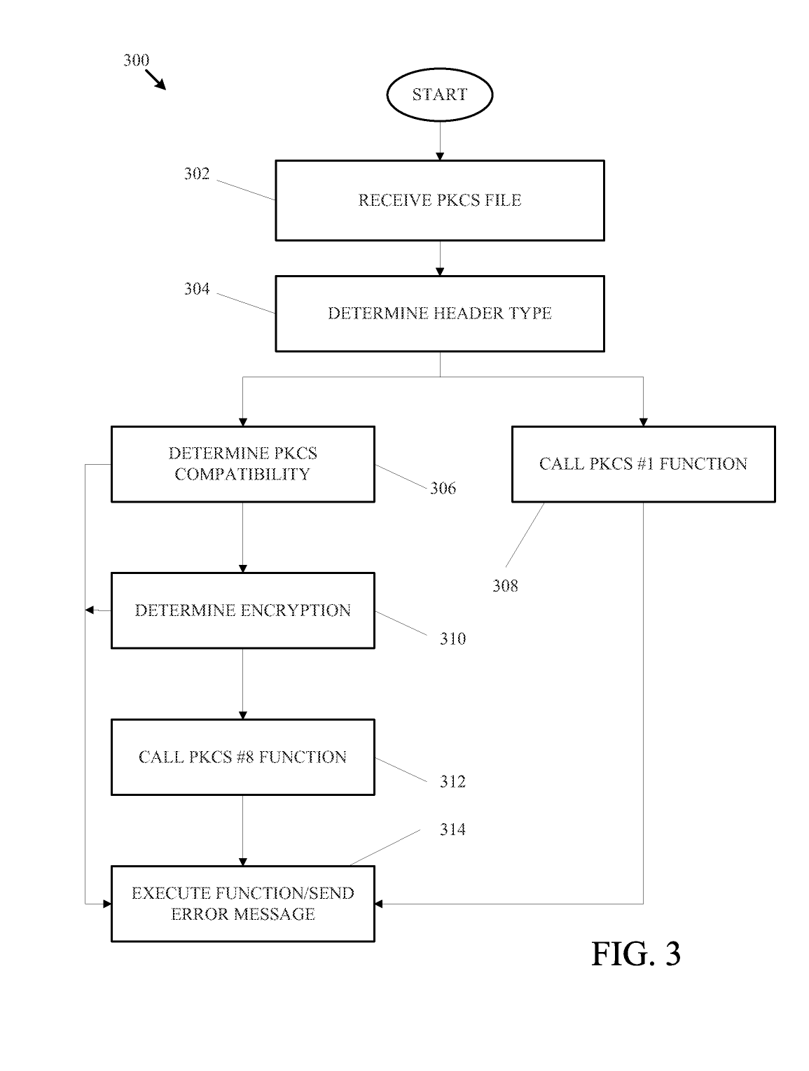

FIG. 3 is a flow chart illustrating an exemplary method for executing a PKCS file transfer between communications platforms. In some embodiments, a PKCS file may be moved from a CPCommOS platform to a CPComm platform. A method 300 may begin at block 302 when one communications platform may receive a PKCS file moved from another communications platform. In some embodiments, the communication platform may receive files in many different PKCS formats. For example, the PKCS file may be in PKCS #1 format, a PKCS #8 format, or a PKCS #8 format encrypted with a PKCS #5 password. At block 304, the communications platform may determine a header and/or footer format of the PKCS tile. As discussed above, PKCS #1 files may have headers in a different format than headers in PKCS #8 files. By recognizing the header/footer format, the communications platform may recognize the type of PKCS file and act accordingly.

In some embodiments, method 300 may continue at block 306 if the header type is in PKCS #8 format and may continue at block 308 if the header is in PKCS #1 format. At block 306, the receiving communications platform may determine its compatibility with the type of received PKCS file. In some embodiments, such as that shown in FIG. 1, the communications platform may not have the capability to process PKCS #8 file formats. In these cases, the communications platform may skip to block 314 and send an error message to be displayed to the user. If the communication platform determines that it is compatible with the PKCS file format, it may proceed to block 310.

At block 308, if the header type is determined to be in PKCS #1 format, encryption utilities in the communications platform may call the applicable PKCS #1 functions from a cryptographic function library. In some embodiments, the encryption utilities may be RSA or DSA key utilities. The communications platform may call PKCS #1 store functions when storing the private key from the PKCS #1 file, while the communications platform may call PKCS #1 load functions when loading the private key from the PKCS #1 file. In some embodiments, if all functions are valid and correctly called, method 300 may proceed to block 314 and execute the called functions. If the functions are invalid, incorrectly called, or some other error occurs, method 300 may proceed to block 314 and send an error message to be displayed to the user.

At block 310, the communications platform may determine whether the PKCS #8 file is encrypted. As discussed above, PKCS #8 format allows for private key encryption. If the PKCS #8 file is encrypted, the communication platform may prompt the user to enter the password. If an incorrect password is entered, the communications platform may proceed to block 314 and send an error message to be displayed to the user. If the file is not encrypted or the correct password is entered, method 300 may proceed to block 312. At block 312, encryption utilities in the communications platform may call the applicable PKCS #8 functions from the cryptographic function library. As discussed above, the encryption utilities may be RSA or DSA key utilities. The communications platform may call PKCS #8 store functions when storing the private key from the PKCS #8 file, while the communications platform may call PKCS #8 load functions when loading the private key from the PKCS #8 file.

When storing a private key, RSA or DSA key utilities in a communications platform may choose to call PKCS #1 functions to create a private key file in PKCS #1 format. In some embodiments, example PKCS #1 store functions may be in the format CL$RSA_store_private_key Or CL$DSA_store_private_key. These functions may be stored in PKCS #1 function module 224. Alternatively, RSA or DSA key utilities may choose to call PKCS #8 functions to create a private key file in PKCS #8 format. In some embodiments, example PKCS #8 store functions may be in the format CL$RSA store_private_key_8 or CL$DSA_store_private_key_8.

Similarly, when loading a private key, the RSA or DSA key utilities may call PKCS #1 or PKCS #8 load functions defending on the format of the private key file. In some embodiments, example PKCS #1 load functions may be in the format CL$RSA_load_private_key or CL$DSA_load_private_key while example PKCS #8 load functions may be in the format CL$RSA_load_private_key_8 or CL$DSA_load_private_key_8. If there is a file encryption password, the communications platform and the utilities may provide it to the cryptographic library as a parameter on the function calls. In some embodiments, if all functions are valid and correctly called, method 300 may proceed to block 314 and execute the called functions. If the functions are invalid, incorrectly called, or some other error occurs, method 300 may proceed to block 314 and send an error message to be displayed to the user,

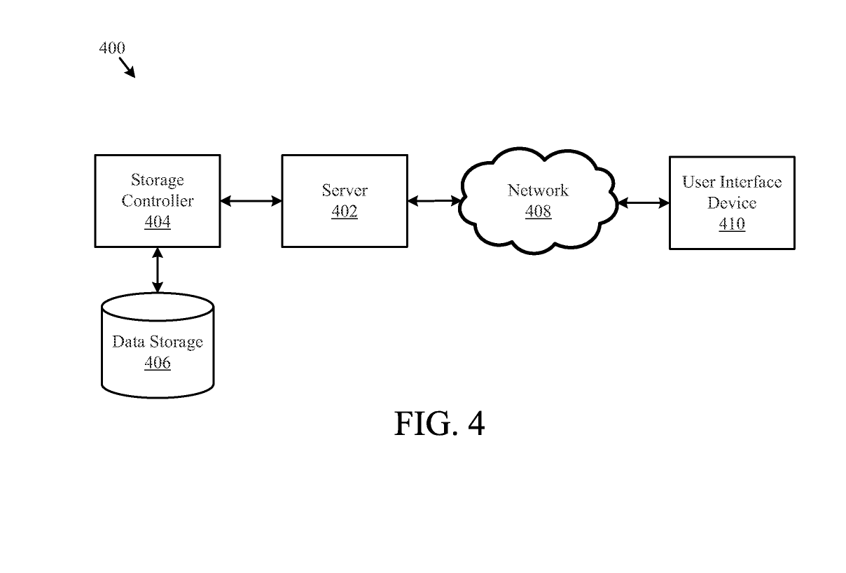

FIG. 4 illustrates one embodiment of a system 400 for an information system, such as a web system for logging print data. The system 400 may include a server 402, a data storage device 406, a network 408, and a user interface device 410. The server 402 may be a dedicated server or one server in a cloud computing system. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone or other a mobile communication device having access to the network 408. When the device 410 is a mobile device, sensors (not shown), such as a camera or accelerometer, may be embedded in the device 410. When the device 410 is a desktop computer the sensors may be embedded in an attachment (not shown) to the device 410. In a further embodiment, the user interface device 410 may access the Internet or other wide area Or local area network to access a web application or web service hosted by the server 402 and provide a user interface for enabling a user to enter or receive information.

The network 408 may facilitate communications of data, such as authentication information, between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 410 accesses the server 402 through an intermediate sever (not shown). For example, in a cloud application the user interface device 410 may access an application server. The application server fulfills requests from the user interface device 410 by accessing a database management system (DBMS). In this embodiment, the user interface device 410 may be a computer or phone executing a Java application making requests to a JBOSS server executing on a Linux server, which fulfills the requests by accessing a relational database management system (RDMS) on a mainframe server.

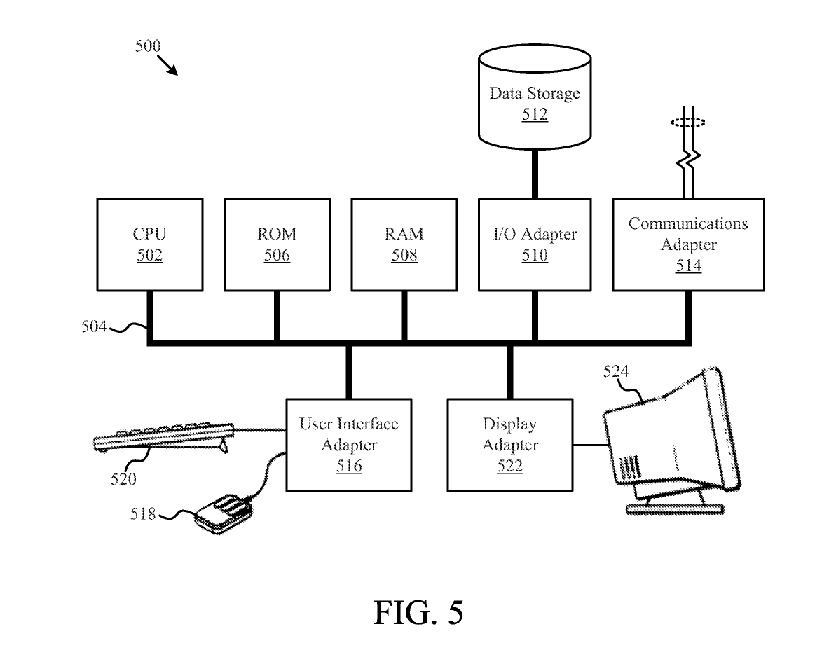

FIG. 5 illustrates a computer system 600 adapted according to certain embodiments of the server 502 and/or the user interface device 610. The central processing unit (“CPU”) 502 is coupled to the system bus 504. The CPU 602 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 600 through a network connection to the I/O adapter 510. The communications adapter 614 may be adapted to couple the computer system 500 to the network 508, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 520, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical, logical, or conceptual.

The applications of the present disclosure are not limited to the architecture of computer system 500. Rather the computer system 500 is provided as an example of one type of computing device that may be adapted to perform the functions of a server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

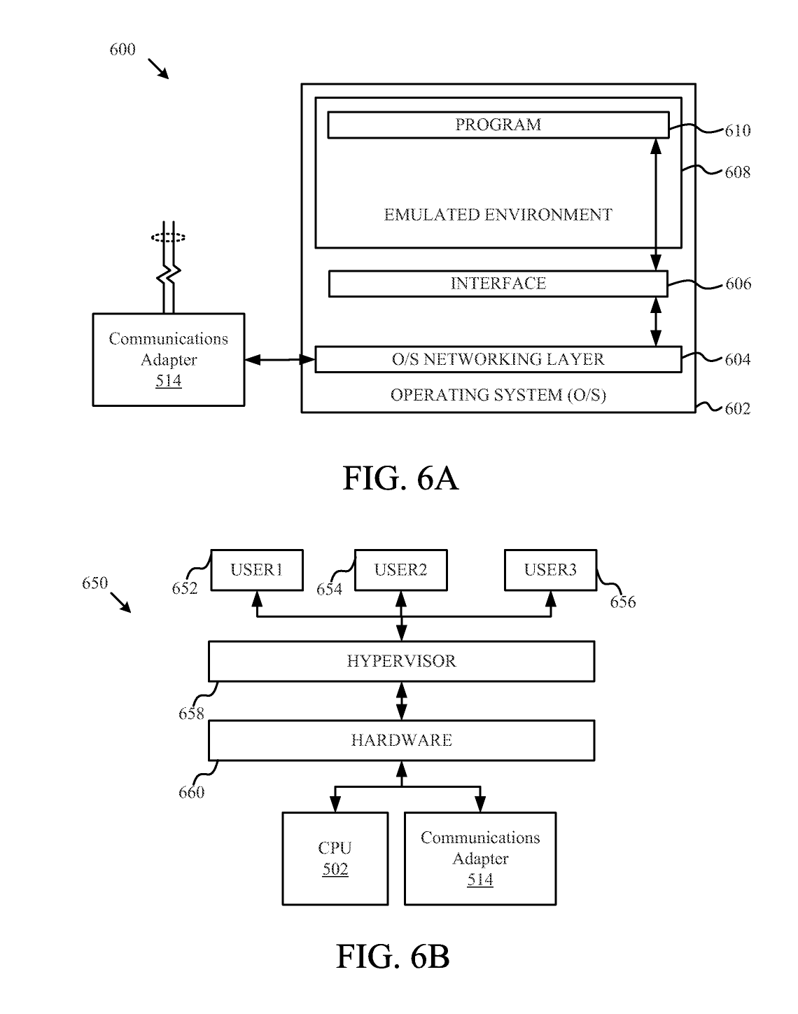

FIG. 6A is a block diagram illustrating a server hosting an emulated software environment for virtualization according to one embodiment of the disclosure. An operating system 602 executing on a server includes drivers for accessing hardware components, such as a networking layer 604 for accessing the communications adapter 514. The operating system 602 may be, for example, Linux. An emulated environment 608 in the operating system 602 executes a program 610, such as CPCommOS. The program 610 accesses the networking layer 604 of the operating system 602 through a non-emulated interface 606, such as XNIOP. The non-emulated interface 706 translates requests from the program 610 executing in the emulated environment 608 for the networking layer 604 of the operating system 602.

In another example, hardware in a computer system may be virtualized through a hypervisor. FIG. 6B is a block diagram illustrating a server hosing an emulated hardware environment according to one embodiment of the disclosure. Users 652, 654, 656 may access the hardware 660 through a hypervisor 658. The hypervisor 658 may be integrated with the hardware 660 to provide virtualization of the hardware 660 without an operating system, such as in the configuration illustrated in FIG. 6A. The hypervisor 658 may provide access to the hardware 660, including the CPU 502 and the communications adaptor 514.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of transferring private key files between two or more communications platforms, the method comprising:
receiving, by a server comprising at least one processor, a private key file;
determining that a header type of the private key file is in a first type of private key file format;
determining that the server has compatibility with the first type of private key file format;
determining that the private key file is encrypted;
calling one or more first cryptographic functions from a cryptographic function library, the one or more cryptographic functions being compatible with the first type of private key file format; and
executing the one or more cryptographic functions.

2. The method of claim 1, further comprising:
determining that a header type of the private key tile is in a second type of private key file format; and
calling one or more second cryptographic functions from a cryptographic function library, the one or more cryptographic functions being compatible with the second type of private key file format.

3. The method of claim 1, where determining that the server has compatibility with the first type of private key file format is performed upon initialization of the server.

4. The method of claim 1, further comprising:
determining that the server does not have compatibility with the first type of private key file format; and
sending at least one error message.

5. The method of claim 1, where the one or more first cryptographic functions comprise a password for decrypting the private key file.

6. The method of claim 1, further comprising:
receiving an incorrect password for the private key file; and
sending at least one error message.

7. A computer program product, comprising:
a non-transitory computer readable medium comprising:
code to receive a command from an operator;
code to receive, by a server comprising at least one processor, a private key file;
code to determine that a header type of the private key file is in a first type of private key file format;
code to determine that the server has compatibility with the first type of private key file format;
code to determine that the private key file is encrypted;
code to call one or more first cryptographic functions from a cryptographic function library, the one or more cryptographic functions being compatible with the first type of private key file format; and
code to execute the one or more cryptographic functions.

8. The computer program product of claim 7, further comprising:
code to determine that a header type of the private key file is in a second type of private key file format; and
code to call one or more second cryptographic functions from a cryptographic function library, the one or more cryptographic functions being compatible with the second type of private key tile format.

9. The computer program product of claim 7, where determining that the server has compatibility with the first type of private key file format is performed upon initialization of the server.

10. The computer program product of claim 7, further comprising:
code to determine that the server does not have compatibility with the first type of private key file format; and
code to send at least one error message.

11. The computer program product of claim 7, where the one or more first cryptographic functions comprise a password for decrypting the private key file.

12. The computer program product of claim 7, further comprising:
code to receive an incorrect password for the private key file; and
code to send at least one error message.

13. An apparatus, comprising:
a memory for storing a database; and
a processor coupled to the memory, in which the processor is configured:
to receive, by a server comprising at least one processor, a private key file;
to determine that a header type of the private key file is in a first type of private key file format;
to determine that the server has compatibility with the first type of private key file format;
to determine that the private key file is encrypted;
to call one or more first cryptographic functions from a cryptographic function library, the one or more cryptographic functions being compatible with the first type of private key file format; and
to execute the one or more cryptographic functions.

14. The apparatus of claim 13, where the processor is further configured:
to determine that a header type of the private key file is in a second type of private key file format; and
to call one or more second cryptographic functions from a cryptographic function library, the one or more cryptographic functions being compatible with the second type of private key file format.

15. The apparatus of claim 13, where the processor determines that the server has compatibility with the first type of private key file format upon initialization of the server.

16. The apparatus of claim 13, where the processor is further configured:
to determine that the server does not have compatibility with the first type of private key file format; and
to send at least one error message.

17. The apparatus of claim 13, where the one or more first cryptographic functions comprise a password for decrypting the private key file.

18. The apparatus of claim 13, where the processor is further configured:
to receive an incorrect password for the private key file; and
to send at least one error message.
